(19) United States
(12) Patent Application Publication
(10) Pub. No.: US 2004/0028789 A1
(43) Pub. Date: Feb. 12, 2004

(54) Baking blend

(76) Inventor: Taryn-Lisa Molle, Durban (ZA)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/375,314

(22) Filed: Feb. 26, 2003

(30) Foreign Application Priority Data
Feb. 26, 2002 (ZA) 2002/1595

(51) Int. Cl. A23L 1/236

(52) U.S. Cl. 426/548

(57) ABSTRACT

A baking blend consisting of a flour substitute and/or bulking agent and/or semi fat replacer having a GI figure of less than 10, typically polydextrose, a sugar substitute having a GI figure of less than 10, typically a sugar alcohol such as lactitol, and a non-nutritive sweetener, typically a heat stable sweetener such as acesulfame-k and/or cyclamate. The baking blend is used in lowering the glycaemic index (GI) of baked products.

### BACKGROUND OF THE INVENTION

THIS invention relates to a baking blend, in particular for use in lowering the glycaemic index (GI) of a baked product.

Products having a lower GI value generally are important for both diabetics and people who are weight conscious. The concern for diabetics is that they obviously do not want a rise in their blood sugar levels. In addition, control over fat content is also essential as diabetes is a strong independent risk factor for heart disease. The recommended fat content is 30% of total dietary intake or to consume less than 10% of total energy from fat. Further, whilst insulin responds to high blood sugar levels, it also acts as a storage hormone and is involved in fat storage. For this reason weight conscious people should eat carbohydrates with a low glycaemic index that will not cause a “peak” in insulin levels. In addition, due to fat being high in calories, a reduction in dietary fat intake is an efficient way to inhibit calorie intake and weight gain.

The glycaemic index is a ranking of foods based on their immediate effect on blood glucose levels. The GI of a product therefore refers to the extent to which the product causes a rise in blood sugar levels, and is scaled from 1 to 100. Products that contain carbohydrates that break down quickly during digestion cause a rapid rise in blood sugar levels and generally have a high GI, typically having GI values above 70. An example is glucose, which has a GI of 100. Products which contain carbohydrates that break down slowly, releasing glucose gradually into the blood stream, have a low GI, generally having GI figures below 55. An example of such a product is fructose, which has a GI of 28. Intermediate GI foods have GI figures of about 55 to 70.

Flour is a product used extensively in baking which has a high glycaemic index above 70 and this value increases even further with baking. In addition, sugars used in such baking products also tend to have high GI figures (sucrose=65), resulting in a baked product having a high glycaemic index that is not suitable for diabetics and people who are weight conscious. In this regard, baked products also tend to have high GI's due to pregelatinisation of the starch and the moisture.

Accordingly, there is always a need for baking ingredients that may be used to replace conventional baking ingredients in order to produce baked products with suitable GI figures.

### SUMMARY OF THE INVENTION

According to the invention, a baking blend comprises:

(a) a flour substitute and/or bulking agent and/or semi fat replacer having a GI figure of less than 10;

(b) a sugar substitute having a GI figure of less than 10; and

(c) a non-nutritive intense sweetener.

The flour substitute and/or bulking agent and/or semi fat replacer is preferably polydextrose and is preferably provided in an amount of about 50 to 80 wt % of the total blend, in particular about 65,3 wt % of the total blend.

The sugar substitute is typically a sugar alcohol, preferably lactitol, and is preferably provided in an amount of about 20 to 40 wt % of the total blend, in particular about 34 wt % of the total blend.

The non-nutritive intense sweetener is preferably a heat stable sweetener such as, for example, acesulfame-k and/or cyclamate, and is preferably provided in an amount of about 0.5 to 2.0 wt % of the total blend, in particular about 0.70 wt % of the total blend. Particularly preferred is a blend of acesulfame-k and cyclamate. In this case, the blend equates to the sweetness of sucrose.

The components (a) and (b) typically behave like fibres and are not readily metabolised by the body, thus not causing a rapid rise in blood sugar levels. In this way they will have an extremely low GI of below 10 if not even a negative GI.

### DETAILED DESCRIPTION OF A PREFERRED EMBODIMENT

The baking blend of the invention consists of a flour substitute, a sugar substitute, and a non-nutritive intense sweetener.

The first ingredient is a flour substitute, typically a partial flour substitute, bulking agent or semi-fat replacer, which is typically polydextrose. In order to be effective, the flour substitute should preferably have a GI of below 10. Polydextrose is used as a bulking agent and semi-fat replacer and readily reduces the glycaemic effect of the flour. It has a low glycaemic index of less than 10, acts as a semi-fat replacer, adds to the maillard browning reaction and retards staling of the final baked product. It also adds to the bulk of the dry ingredients, which may be lost due to the reduction in the amount of flour and sugar. The polydextrose also acts as a sugar replacement that lowers the calories of the baked product. Other fibres such as simplesse®, Litessse®, possibly inulin® and others, may also be used, although their relative quantities would have to be determined, as the wrong concentrations may cause laxative effects.

Where polydextrose is used, it is preferably provided in an amount of about 50 to 80 wt %, in particular about 65,3 wt % of the blend. A certain amount of polydextrose is passed out of the system, without being metabolized. Accordingly, the amount used in the blend must be carefully selected in order to avoid, or at least reduce, a laxative effect.

The second ingredient is a sugar substitute, typically lactitol. In order to be effective, the sugar substitute should have a GI value of preferably below 10. Any polyhydric alcohols that have a low GI and are in the crystalline form such as xylitol, sorbitol and mannitol, for example, may also be used.

Lactitol is a sugar alcohol that is about 0.4 times as sweet as sugar. It is used either alone or in combination with the polydextrose as a sugar substitute. As the lactitol has a GI of −1, it significantly lowers the GI of the baked product as well as the calorie content as some of it is passed out of the body in a similar manner to a non-metabolised fiber. As a result of a possible laxative effect, its content in the blend must also be carefully selected. Typically, the lactitol is included in the blend in an amount of about 20 to about 40 wt % of the total blend, in particular about 34 wt % of the total blend.

As a result of replacing sugar in the baking process, the overall units of sweetness are reduced. Accordingly, a non-nutritive intense sweetener that does not cause fluctuations in blood sugar levels is added to the blend to make up the lost units of sweetness. A typical example is a sweetener blend composed of two heat stable sweeteners, acesulfame-k and cyclamate, obtainable as HA201 from Cape Sweeteners, South Africa. Although acesulfame-k has a good taste profile and is suitable as a sweetener on its own, due to its relative high cost, cyclamate is added to reduce the overall cost. In order for the sweetener or sweetener blend to be effective, it must be heat stable. Accordingly, sweeteners such as aspartame are not suitable as they lose some sweetness due to a change in their structure when exposed to high temperatures for an extended period of time, as typically experienced in conventional baking processes.

The intense sweetener, because of its nature, is usually provided in small amounts, typically in amounts of about 0.5% to 2 wt % of the total blend, in particular about 0,7 wt % of the total blend.

The baking blend is a creamy white powder that has the equivalent sweetness and viscosity to sucrose. It is stable at 60° C. for 90 days.

An example of a typical baking blend formulated according to the invention is set out below.

TABLE 1

| Ingredients | 100 g sample | | 500 g sample | |
|---|---|---|---|---|
| Lactitol | 34.00 | g | 170.00 | g |
| Polydextrose | 65.30 | g | 326.50 | g |
| AD100 (now known as | 0.70 | g | 3.50 | g |
| HA201) | | | | |

The above baking blend was used in a number of baked products as set out in the following non-limiting examples.

### EXAMPLE 1

Fat Free, Sugar Free, Swiss Roll

| Ingredients | Measurement | |
|---|---|---|
| Cake flour | 125 | ml |
| Baking powder | 5 | ml |
| Salt | 1 | ml |
| Eggs | 3 Separated | |
| Lemon juice | 12.5 | ml |
| Vanilla essence | 2.5 | ml |
| Baking blend | 125 | ml |

Method

Sift the flour, baking powder, baking blend and salt together.

Beat egg yolks, lemon juice and vanilla essence together.

Beat the egg whites until stiff and add egg yolk mixture and dry ingredients slowly.

Line a 35×285 cm baking tin with greased paper and pour mixture into it.

Bake in a hot oven at 200° C. for 10-12 minutes.

Turn out onto a damp cloth and spread with *jam and cut off edges. * This was made using pure fruit pulp and 0,15 g per 100 g fruit of CD10 (now known as GU301) sweetener blend. A diabetic jam may also be used.

Roll up immediately.

Allow to cool.

Serving suggestion: sprinkle with crystalline fructose.

### EXAMPLE 2

Fat Free, Sugar Free, Chocolate Swiss Roll

| Ingredients | Measurement | |
|---|---|---|
| Cake flour | 125 | ml |
| Baking powder | 5 | ml |
| Salt | 1 | ml |
| Eggs | 3 Separated | |
| Cocoa | 10 | ml |
| Baking blend | 125 | ml |

Method

Sift the flour, baking powder, baking blend, cocoa and salt together.

Beat egg yolks, lemon juice and vanilla together.

Beat the egg whites until stiff and add egg yolk mixture and dry ingredients slowly.

Line a 35×285 cm baking tin with greased paper and pour mixture into it.

Bake in a hot oven at 200° C. for 10-12 minutes.

Turn out onto a damp cloth and spread with diabetic custard.

Roll up immediately.

Allow to cool.

### EXAMPLE 3

Mock Sponge Cake

| Ingredients | Measurement | |
|---|---|---|
| Cake flour | 250 | ml |
| Baking powder | 7 | ml |
| Salt | 1 | ml |
| Eggs | 2 | |
| Cold water | 62.5 | ml |
| Vanilla essence | 5 | ml |
| Baking blend | 125 | ml |

Method

Beat whole eggs until light and fluffy, add vanilla and water.

Add sifted dry ingredients; mix well on electric mixer for 1 minute.

Bake @200° C. for 15 min.

### EXAMPLE 4

Marble Cake

| Ingredients | Measurement | |
|---|---|---|
| Cake flour | 250 | ml |
| Baking powder | 7 | ml |
| Salt | 1 | ml |
| Eggs | 2 | |
| Cold water | 62.5 | ml |
| Vanilla essence | 5 | ml |
| Baking blend | 125 | ml |

Now make this formulation up, divide the mixture into two and add 10 mls of cocoa to one half. Pour into cake tin spoon by spoon of each mix.

Method

Beat whole eggs until light and fluffy, add vanilla and water.

Add sifted dry ingredients, mix well on electric mixer for 1 minute.

Bake @200° C. for 15 min.

In tests carried out on the baking blend of the invention, samples baked with the baking blend were sent to the GI foundation of South Africa for testing. Controls were made with real sugar and fat. This trial involved volunteers who had to use glucometers to measure rises in their blood sugar levels from standard baked goods compared to those produced with the baking blend of the invention. It was found that when used in an application the baking blend of the invention reduced the GI of the respective products by 30-50%.

Although the above recipes have been specifically developed for using the baking blend of the invention, many existing recipes could be adapted for use with the baking blend of the invention using the following three easy steps.

1. Omit the sugar and replace with the baking blend of the invention, in the same quantity.

2. Omit the fat or greatly reduce the fat (in the case of biscuits some fat is needed).

3. Add the baking blend to the dry ingredients and carry out the recipe as per normal.

In the industrial market the baking blend can be added to a dry mix, in the same way that sugar is normally added with only minor tweaking, if any, of the formulation.

In addition to lowering the GI values of products, the baking blend of the invention also has a lower kilojoule value than conventional carbohydrates and other food ingredients.

It therefore offers a kilojoule reduction in baked goods compared to other food components. As can be seen below the baking blend, on average, contains less than half the kilojoules of other food components.

| | | |
|---|---|---|
| Baking blend | 6.48 | kJ/g |
| Protein | 17 | kJ/g |
| Carbohydrates | 17 | kJ/g |
| Organic acids | 13 | kJ/g |
| Fat | 37 | kJ/g |

1 kJ = 0.23885 Kcal
1 kcal = 4.184 g

It is known that type II diabetes can be controlled entirely with diet and exercise and patients often need to lower their total body fat and triglycerides. By consuming fewer calories the body will burn fat as energy via a ketogenic cycle. The use of the baking blend in producing baked products is therefore effective in actively controlling type II diabetes.

The baking blend of the invention is a powdered blend that replaces sugar on a 1:1 ratio, maintaining functionality and sweetness while offering a reduction in kilojoules and the GI. Not only does it provide for a low kilojoule product but also replaces the actual scientific functionality of the sugar and fat, as set out in Table 2 below.

| Functional Property | Benefit |
|---|---|
| Sweetener | The heat stable non-nutritive |
| | sweeteners in the baking blend |
| | replace the sweetness of the |
| | “removed” sugar |
| Humectant | Maintains moisture |
| Bulking Agent | Replaces solids and improves |
| | texture |
| Maillard Browning | Develops flavour and colour |
| Replaces fat and sugar | Reduces calories |
| Texturiser | Improves volume, crumb and cell |
| | structure |
| Increases starch gelatinisation | Promotes peak viscosity and set |
| | temperature |
| Reduces water activity | Increases microbial activity |

In summary, products produced using the baking blend of the invention are low in fat, have a low GI (below 55, depending on the application) and contain no sugar. They are therefore also reduced calorie products.

I claim:

1. A baking blend comprising:
(a) a flour substitute and/or bulking agent and/or semi fat replacer having a GI figure of less than 10;
(b) a sugar substitute having a GI figure of less than 10; and
(c) a non-nutritive intense sweetener.

2. A baking blend according to claim 1, wherein the flour substitute and/or bulking agent and/or semi fat replacer is polydextrose.

3. A baking blend according to claim 2, wherein the polydextrose is provided in an amount of about 50 to 80 wt % of the total blend.

4. A baking blend according to claim 3, wherein the polydextrose is provided in an amount about 65,3 wt % of the total blend.

5. A baking blend according to claim 1, wherein the sugar substitute is a sugar alcohol.

6. A baking blend according to claim 5, wherein the sugar alcohol is lactitol.

7. A baking blend according to claim 5, wherein the sugar alcohol is provided in an amount of about 20 to 40 wt % of the total blend.

8. A baking blend according to claim 7, wherein the sugar alcohol is provided in an amount of about 34 wt % of the total blend.

9. A baking blend according to claim 1, wherein the sweetener is a heat stable sweetener.

10. A baking blend according to claim 9, wherein the sweetener is acesulfame-k and/or cyclamate.

11. A baking blend according to claim 9, wherein the sweetener is provided in an amount of about 0.5 to 2.0 wt % of the total blend.

12. A baking blend according to claim 11, wherein the sweetener is provided in an amount of about 0.70 wt % of the total blend.

13. A baking blend according to claim 9, wherein the sweetener is a blend of acesulfame-k and cyclamate.
